(19) United States
(12) Patent Application Publication
(10) Pub. No.: US 2001/0030788 A1
(43) Pub. Date: Oct. 18, 2001

(54) Broadband thermal light source, an optical transmission system using a broadband optical light source, use of broadband optical light source and a process for demultiplexing

(76) Inventor: Thomas Pfeiffer, Stuttgart (DE)

Correspondence Address: SUGHRUE, MION, ZINN, MACPEAK & SEAS, PLLC, 2100 Pennsylvania Avenue, N.W., Washington, DC, 20037-3213, US

(21) Appl. No.: 09/799,063

(22) Filed: Mar. 6, 2001

(30) Foreign Application Priority Data
Mar. 20, 2000 (DE) 100 13 718.0
Jun. 20, 2000 (DE) 100 29 336.0

(51) Int. Cl. H04J 14/08; H04B 10/04

(52) U.S. Cl. 359/136; 359/180

(57) ABSTRACT

A broadband optical light source 1 is proposed containing a laser diode and a modulator connected thereto as well as an emitter for amplified spontaneous emission. The optical input of the emitter for amplified spontaneous emission is connected to the output of the laser diode. Additionally an optical transmission system using a broadband optical light source is proposed.

A broadband optical light source 1 is proposed comprising a laser diode and a modulator connected thereto as well as an emitter for amplified spontaneous emission. The optical input of the emitter for amplified spontaneous emission is connected to the output of the laser diode. The use of the broadband optical light source as logical decision unit or demultiplexer is also proposed.

### BACKGROUND

The invention is based on a broadband thermal light source and an optical transmission system using a broadband optical light source, and upon the use of the broadband optical light source, in particular for the demultiplexing of signals.

Here the broadband optical light source comprises a laser diode and a modulator connected thereto, and an emitter for amplified spontaneous emission (ASE), the optical input of the emitter for amplified spontaneous emission (ASE) being connected to the output of the laser diode, and the output of the emitter for amplified spontaneous emission (ASE) being connected to a transmission link in such manner that only the broadband ASE signal components can be transmitted.

Broadband thermal light sources and transmission systems which employ such light sources are known from the prior art. For example, DE 198 33 549.0 has described a broadband thermal light source and an optical transmission system. The broadband thermal light source is a LED. The very broad band spectrum of the LED is coded with the aid of optical filters. The coded optical signals are transmitted in the transmission system, and in the receiver are selected from the stream of coded signals by means of special filtering. The problem concerning the use of broadband LEDs is the modulation speed at which the data signal is impressed upon the optical signal. The modulation frequency here is distinctly below 1 GHz. However, the requirements of an optical transmission system are for substantially higher data rates.

Therefore the object of the invention is to provide a broadband optical light source which can be modulated with a high modulation frequency and can be used in optical transmission systems with a CDM (code division multiplex) process.

### DESCRIPTION

The broadband optical light source according to the invention and the use thereof in an optical transmission system facilitates data modulation for data rates exceeding 1 GHz using the CDM process based on broadband optical sources. Advantageously, the high-speed modulation of a laser diode here is combined with the broadband characteristic of an emitter for amplified spontaneous emission (ASE) to form a new light source.

In an advantageous embodiment an optical semiconductor amplifier is used as broadband source for amplified spontaneous emission.

In another advantageous embodiment a LED is provided as emitter for amplified spontaneous emission.

The broadband optical light source according to the invention has the advantage that its output signal is digitally inverted relative to the signal of the modulator. The optical transmission system employing the broadband optical light source according to the invention uses the CDM process for transmission rates exceeding 1 Gbit/s per CDM channel. In the optical transmission system the two components of the broadband optical light source advantageously are spatially distributed and are located in the subscriber station and a network node of the transmission system. In the system use is made of the narrow-band emission in a first stage. Due to the narrow-band transmission across the first transmission section of the optical transmission system, in which different distances to the subscriber stations must be traversed, dispersion problems are easier to deal with. In another advantageous embodiment, all the optical inputs of the network node are connected to one single emitter for amplified spontaneous emission. In such a transmission system, in the network node a code conversion of the signals already coded in the subscriber stations is performed or, in another embodiment, a conversion from TDM to CDM coded signals is performed.

In the circuit according to the invention this light source also serves as NOR gate or a demultiplexer for optically transmitted signals.

Exemplary embodiments of the invention are illustrated in the Figures and explained in detail in the following description. In the drawing:

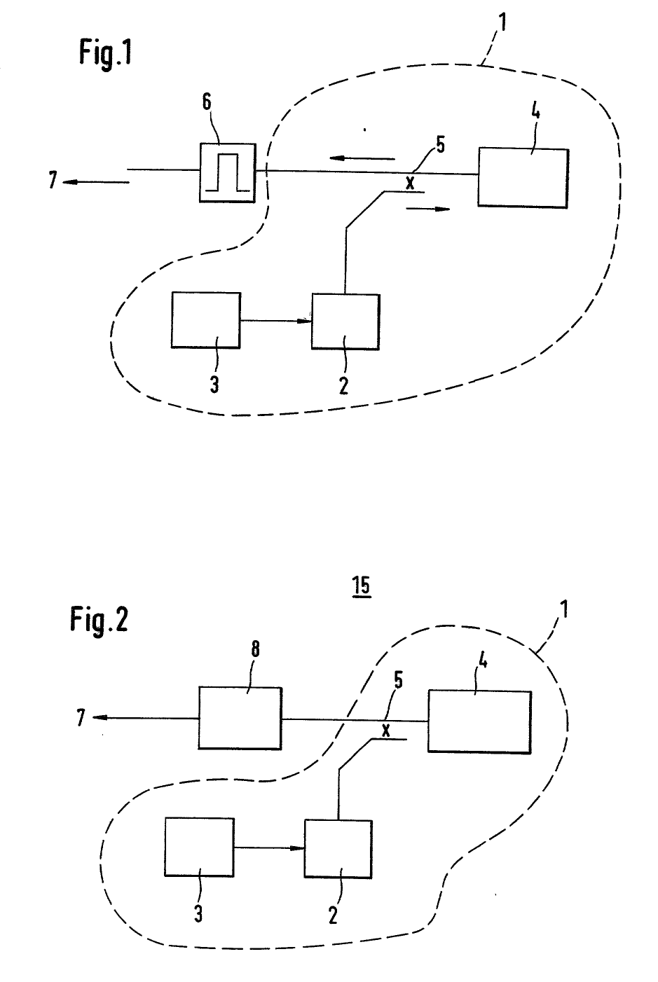

FIG. 1 illustrates the principle of a broadband optical light source;

FIG. 2 illustrates an example of a subscriber station with light source;

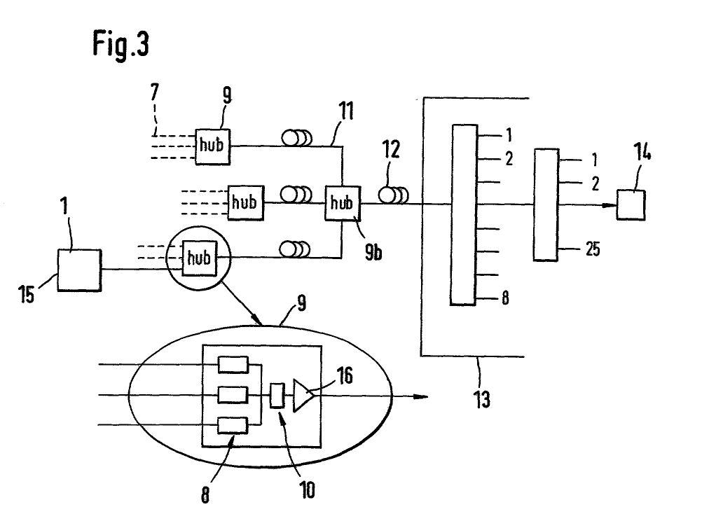

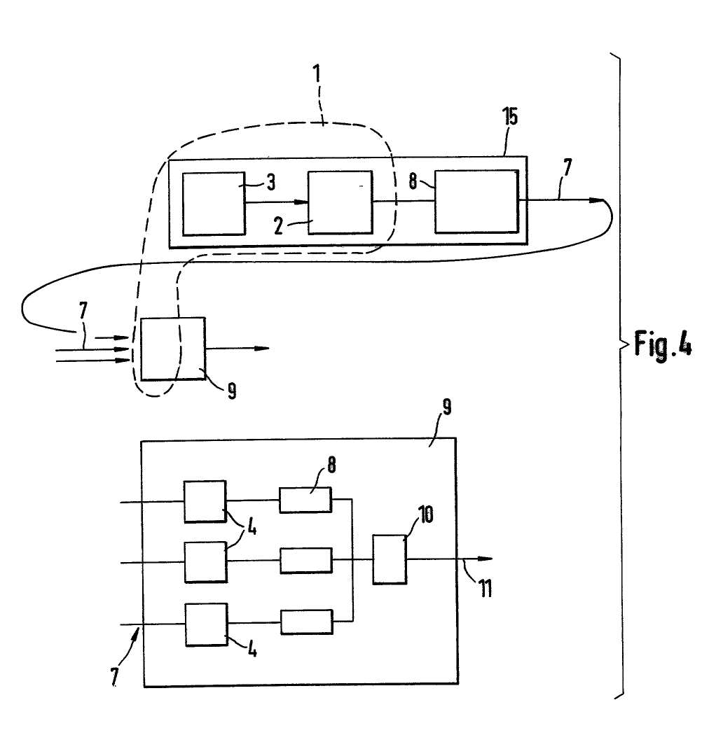

FIG. 3 illustrates an example of a transmission system;

FIG. 4 illustrates a detail of an optical transmission system with subscriber station and network node;

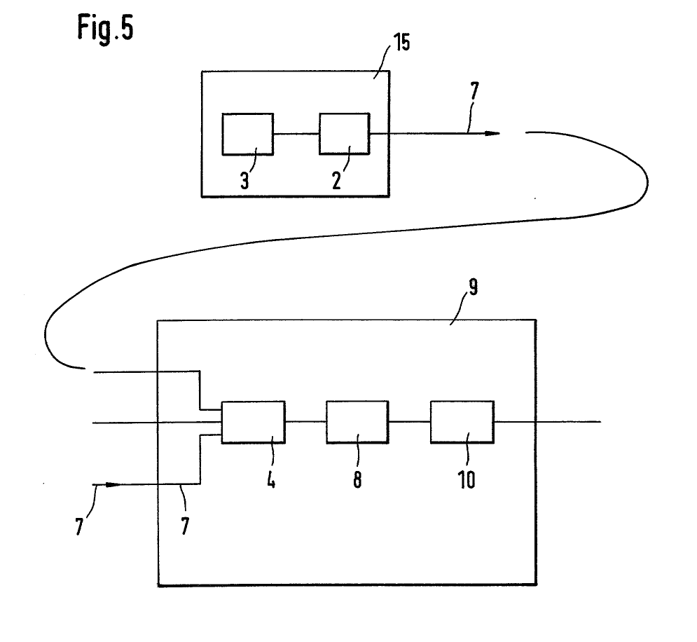

FIG. 5 illustrates another exemplary embodiment of the optical transmission system with a detail diagram showing subscriber station and network node;

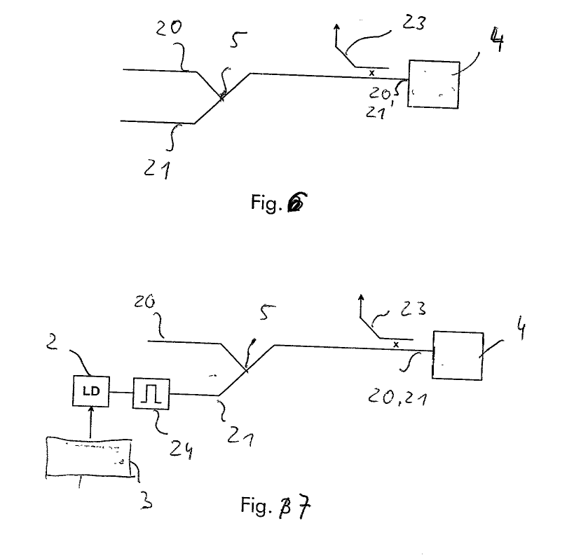

FIG. 6 illustrates an example of a circuit as NOR gate;

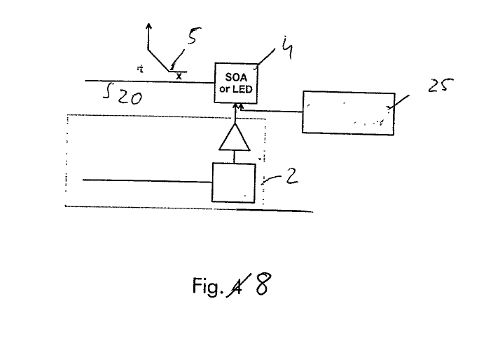

FIG. 7 illustrates an example of a circuit for high data rates;

FIG. 8 illustrates an example of a circuit with direct modulation of the emitter.

FIG. 1 illustrates a broadband optical light source 1 consisting of the following components: A laser diode 2 is connected at its input end to a modulator 3. The optical output of the laser diode is connected to an optical coupler 5. The output of the optical coupler 5 is connected to the input of an emitter 4 for amplified spontaneous emission (ASE). The optical output of the emitter 4 for amplified spontaneous emission (ASE), which in the drawing has not been shown separately from the optical input, is connected to the input of an optical filter 6. This optical filter no longer necessarily forms a part of the broadband optical light source 1 and therefore has been shown outside the boundary line. The output of the optical filter 6 is connected to a first transmission link 7 for the transmission of the optical signals.

The main difficulty relating to the use of previously known broadband light sources is that the spectrum of LEDs contains only small components of stimulated emission. Only when a large component of stimulated emission is contained in the emission of a light source is it possible to attain fast modulation rates. This is due to the fact that the density of the electric charge carriers in the active zone of the component is rapidly reduced, i.e. the inversion rapidly diminishes. If a semiconductor amplifier is taken as an example of an emitter 4, upon the application of a constant current the amplifier emits a constant signal consisting of ASE. The ASE occurs due to the spontaneous diminishment of the inversion state produced by the constant current. The ASE signal contains only a very small component of coherent emission. Therefore it is also clear that even a semiconductor amplifier which emits a broadband ASE cannot be modulated at an adequate speed. If on the other hand a coherent optical signal is fed into the optical semiconductor amplifier, the ASE can diminish just as fast as in the case of a stimulated emission in a laser. In this way the ASE spectrum of the semiconductor amplifier can be modulated at a comparable speed to a semiconductor laser. The semiconductor amplifier is excited with a constant operating current so that it emits a constant ASE. This emission is constant for such time as no optical signal is applied to the semiconductor laser. The laser diode is electrically modulated with the data rate via the modulator 3. When the laser diode emits a “1” (light on), the ASE of the semiconductor amplifier is minimised. If the laser diode emits a “0” (light off), the semiconductor amplifier emits a maximum of ASE. In this case the modulated ASE is used in the reverse direction. In the forwards direction the signal containing substantially larger components of the signal of the laser diode is suppressed. In the reverse direction only small components of the signal of the laser diode are contained in the spectrum of the ASE of the semiconductor amplifier. These signal components, which are contained in the ASE signal due to reflections or dispersions, are filtered out of the ASE spectrum by a filter 6 in this embodiment.

In another embodiment the ASE spectrum of the semiconductor amplifier is used in the forwards direction. In such an embodiment the optical filter 6 is essential to suppress the light of the laser diode. The modulated ASE spectrum has a large bandwidth. The modulation speed distinctly exceeds 1 GHz, and in a trial a modulation frequency of 2.5 GBit/s was possible. The logic of the modulated ASE spectrum is inverted relative to the electric modulation signal across the modulator.

In another embodiment the semiconductor amplifier is replaced by a LED operated in continuous wave mode. Also in this case the spontaneous amplified emission can be requested by querying the inversion state with the aid of the light of the laser diode.

FIG. 2 illustrates another embodiment of the broadband light source 1. In addition to the light source described in FIG. 1, the overall assembly, such as can be found for example in a subscriber station of an optical transmission system, contains an optical coder 8. In the simplest case an optical coder is an optical filter. This can consist of a Fabry-Perot filter or a Mach-Zehnder filter. The filter is not limited to these two embodiments, any other form of optical coding being suitable for the transmission system according to the invention.

FIG. 3 illustrates an example of a complete optical transmission system in which the light source according to the invention can be used. A broadband light source 1 in a subscriber station 15 is connected to a network node 9. The light source has a bandwidth which fills the entire bandwidth of the wavelength division multiplex. The network node 9 has several inputs and one output. Inputs and outputs are connected to optical transmission links 7, 11. The various, broadband light sources 1 of the network subscribers 15 are connected to the input end. The outputs of the network nodes 9 are connected to the input of a further network node 9b. The output of the network node 9b is connected to a further transmission link 12. This transmission link 12 terminates at the receiving end in a distributor 13. The distributor 13 is schematically illustrated in two stages. It contains a spectral band selection stage and an optical decoder. The outputs of the optical decoder are in each case connected to an optical receiver 14.

The network node 9 has been shown in a detail diagram. The optical inputs of the network node 9 terminate in optical coders 8. The outputs of the optical coders 8 terminate in a spectral band selection means 10. The output of the spectral band selection means is connected to the input of an amplifier 16. The output of the amplifier 16 is connected to the transmission link 11.

The transmitters 1 transmit in a broad wavelength band. These broadband signals are then optically coded. For this purpose the optical signals pass through optical filters. These filters are arranged either directly in the transmitters or in the network nodes 9 in which they have been shown as optical coders 8. In the network node, from the broadband coded signals, coded signals only covering the bandwidth of a WDM band are separated by the band selection means 10.

FIG. 4 illustrates a detail of the optical transmission system limited to subscriber station 15 and network node 9. A part of the optical light source 1 is located within the subscriber station 15. This part comprises the laser diode 2 which is connected to the modulator 3. The output of the laser diode 2 is connected to the transmission link 7 via an optical coder 8. The transmission links 7 terminate at the input of a network node 9. The detail diagram shows the network node 9. The transmission links 7 are connected to emitters 4 for amplified spontaneous emission. Each emitter 4 is connected to the input of a spectral coder 10 whose output is connected to the input of an optical band selection means 8. The output of the spectral band selection means is connected to the second transmission link 11. In this exemplary embodiment it can be seen that the broadband light source 1 is distributed between two different locations. One part of the light source—comprising the laser diode 2—is located in the subscriber station 15, while the second main part, the emitter for amplified spontaneous emission, is located within the network node of the transmission system. Each incoming optical signal, which in this embodiment has a narrow band, is in each case connected to an emitter 4 for ASE, for example a semiconductor amplifier at the network node 9. As a result the conversion from narrow-band to broadband signal is completed only in the network node. Such an embodiment has the advantage that the transmission link 7, a transmission link to which subscribers are connected at different distances, is traversed on a narrow band. Problems relating to dispersion due to transmission links of different lengths are therefore preprogrammed. By using a first stage with narrow-band transmission, these problems are reduced. The conversion into a broadband signal then takes place only at the network node 9. The further processing of the signal and the transmission to a receiver take place over defined distances, whereby it is possible to make provisions for avoiding disturbances caused by dispersion.

FIG. 5 illustrates another embodiment showing a detail of the subscriber station 15 and the network node 9. A transmission system of this kind again employs a narrow-band transmission from the subscriber station 15 to the network node 9 in a first stage. At the network node 9 the transmission links 7 converge in one single emitter 4 for ASE. The transmission takes place in TDM in a first section 7 of the transmission system. Only at the network node 9 are the TDM signals converted into broadband signals and then transmitted across the transmission link 11 and 12 in optically coded form.

Another exemplary embodiment of the transmission system (not shown as a drawing) employs a broadband optical source according to FIG. 2. In this case a coded broadband signal is actually generated in the subscriber station by the use of the coder. The coded broadband signal is forwarded to the network node 9 via the first part of the transmission link 7. In the network node 9 the receiving emitter 4 converts the broadband coded spectrum into a continuous structureless ASE spectrum. The spectrum is again supplied to a coder 8. A system construction of this kind permits a code conversion of a coded signal. In this way a purely optical conversion or a change-over from one optical code to another can take place. The original signals of the electric modulation are fully retained. A system construction of this kind is also used to convert an optically coded channel from one wavelength band into another, using the same optical code. In another case the conversion takes place from one optical band to another optical band with simultaneous conversion of the optical code. In the overall optical transmission system, the use of the broadband light source 1 results in an inversion of the electrical modulation signal. In a situation in which an inversion is not permitted for the transmission system, the driver of the laser diode is operated with inverted logic. Another possibility consists of cascading two emitters for ASE, for example two semiconductor amplifiers.

In an alternative embodiment the broadband light source according to the invention is not operated with an external modulator but instead the laser diode is directly controlled with a modulated laser current. This operating mode has the advantage that different modulation schemes can be used. A conversion from NRZ to RZ signals can easily be achieved.

The broadband light source according to the invention can also be used as preamplifier in a receiver. Prior to the O/E conversion the modulated received light is input-coupled into the beam path of the laser diode. The modulated, transmitted signal is input-coupled into the emitter for ASE together with the light of the laser diode. As a result a broadband amplified signal is obtained which can be subsequently O/E converted.

FIG. 6 illustrates an embodiment of the broadband light source 1 in a circuit as NOR gate. Here the signal input 20 is connected to a laser diode 2 with modulator 3 either directly locally or also via a transmission link. The input signal 20 is connected via a coupler 5 to the input of the emitter 4. The coupler 5 is additionally connected to a source for a gate signal 21. If the gate signal 21 for the emitter 4 is of sufficient strength to operate the emitter in saturation, no ASE is emitted. This effect is utilized to operate the emitter as logical gate. The gate signal 21 leads to a “bleaching out” effect of the ASE when a “1” is transmitted. Only when no gate signal 21 is applied does the input signal switch between the states “1” and “0”. At the output end a logical broadband ASE signal 23 is emitted. This signal follows the logical table shown below.

If no gate signal is applied, the emitter 4 in each case emits an ASE signal 23 inverted relative to the input signal 20.

Signal

| Gate | 0 | 1 |
|---|---|---|
| 0 | 1 | 0 |
| 1 | 0 | 0 |

FIG. 7 illustrates an exemplary embodiment for use in the case of high data rates. The source for the gate signal 21 is a laser diode 2 as in the case of the signal source. This laser diode 2 is connected to an external modulator 3. The output of the laser diode 2 is connected to an optical filter 24, for example a Bragg filter. The output of the optical filter 24 is connected to the coupler 5, and via the coupler is connected to the emitter 4 for ASE.

For high data rate signals, the pulses of the gate signal 21 must have a length comparable with the bit period of the signal. High data rates thus also necessitate high modulation frequencies for the laser diode of the gate signal. For the operation of the circuit according to the invention it is therefore advantageous to reduce the speed requirements for the modulation of the laser diode. This is possible by means of the circuit according to FIG. 3 in the case of periodic signals 20. The laser diode for the gate signal is operated with current having a small amplitude. The characteristic curve of this operation is sinusoidal. In this operation the frequency of the laser diode is also varied. If the frequency of the gate signal 21 occurs at the maximum of the optical filter, this signal is reflected back. At this instant no gate signal reaches the emitter for ASE 4 and the gate signal is “0”. If the frequency of the laser diode 2 is close to the reflection maximum of the optical filter 24 the signal is transmitted.

A gate signal “1” occurs. As maximum and minimum are traversed twice in each period of the operation of the laser diode, the control frequency for the laser current is half the gate frequency. The length of the gate signal is defined via the amplitude of the control current of the laser diode.

The embodiment illustrated in FIG. 3 operates for example as demultiplexer for TDM signals as input signals 20.

FIG. 4 illustrates another advantageous embodiment of a demultiplexer of TDM signals. Here the emitter for ASE 4 is operated with a variable saturation current of a current source 25. This current represents the first branch of the signals in respect of which a logical decision is to be made. The second branch is generated by the optical input signal 20 as already described.

If, in such a variant, a logical decision is to be made between two optical signals, an optical signal can be electrically converted and used to generate the saturation current.

The logical table of this embodiment is as follows:

Signal

| Current | 0 | 1 |
|---|---|---|
| 0 | 0 | 0 |
| 1 | 1 | 0 |

The optical output signal corresponds to the inverted optical input signal.

1. A broadband optical light source with a laser diode and a modulator connected thereto and with an emitter for amplified spontaneous emission (ASE), wherein the optical input of the emitter for amplified spontaneous emission (ASE) is connected to the output of the laser diode and the output of the emitter for amplified spontaneous emission (ASE) is connected to a transmission link in such manner that only the broadband ASE signal parts can be transmitted.

2. A broadband optical light source according to claim 1, wherein the emitter for amplified spontaneous emission is a LED or an optical semiconductor amplifier.

3. A broadband optical light source according to claim 1 wherein the modulator (3) permits a modulation frequency exceeding 1 GHz.

4. A broadband optical light source (according to claim 1 wherein the amplified spontaneous emission at the optical output of the emitter) for amplified spontaneous emission (ASE) comprises a signal which is inverted in relation to the laser diode.

5. An optical transmission system using a broadband optical light source according to claim 1 which operates with a CDM (code division multiplex) process, comprising subscriber stations, optical coders, network nodes spectral band selection means, transmission links, optical decoders and optical receivers.

6. An optical transmission system according to claim 5, wherein the laser diode is installed in individual subscriber stations and the emitter for spontaneous stimulated emission (ASE) is installed in the network node.

7. An optical transmission system according to claim 5, wherein all the optical inputs of the network node for the transmission links are connected to an emitter for spontaneous stimulated emission (ASE), and that in the network node optical signals incoming in time division multiplex (TDM) pass through a CDM coder downstream of the emitter for spontaneous amplified emission.

8. An optical transmission system according to claim 5, wherein a broadband light source and the coder are installed in a subscriber station and the emitter for spontaneous amplified emission is installed in the network node, and that a code converter) for the signals is provided in the network node.

9. A broadband optical light source according to claim 1, wherein the modulation of the laser diode (2) is effected by means of a direct modulation of the laser current.

10. The use of a broadband optical light source according to claim 1 as preamplifier in a receiver of a transmission system.

11. A broadband optical light source according to claim 1, with a signal input for an optical signal and a logical input parallel to the signal input.

12. A broadband optical light source according to claim 11, characterised in that the emitter for amplified spontaneous emission is saturated with a signal of the logical input.

13. A broadband optical light source according to claim 11 wherein the logical input is an optical input.

14. A broadband optical light source according to claim 11 wherein the logical input is an electrical input.

15. The use of an optical light source according to claim 11 as logical decision unit between two optical signals.

16. The use of an optical light source according to claim 11 as logical decision unit between an optical and an electrical signal.

17. The use of an optical light source according to claim 11 as demultiplexer for TDM signals.

18. A process for demultiplexing TDM signals with an optical light source according to claim 11, wherein the logical signal is varied in frequency within two bit periods and passes through an optical filter with a reflection maximum at a middle frequency, and that when the variable frequency passes through the reflection maximum, the logical signal traverses one minimum and two maxima and is then fed into the emitter.
